(19) United States
(12) Patent Application Publication
(10) Pub. No.: US 2022/0311938 A1
(43) Pub. Date: Sep. 29, 2022

(54) IMAGE CAPTURE WITH EXPANDED FIELD OF VIEW

(71) Applicant: QUALCOMM Incorporated, San Diego, CA (US)

(72) Inventors: Edwin Chongwoo PARK, San Diego, CA (US); Russell GRUHLKE, San Jose, CA (US)

(21) Appl. No.: 17/211,718

(22) Filed: Mar. 24, 2021

(51) Int. Cl. H04N 5/232; H04N 5/225; G02B 27/00; G02B 5/18; G02B 26/08; G02F 1/137

(52) U.S. Cl. CPC H04N 5/23238; H04N 5/2254; G02B 27/0081; G02B 5/1842; G02B 5/1866; G02B 26/0833; G02F 1/137

(57) ABSTRACT

Methods, systems, computer-readable media, and apparatuses for image capture are presented. An apparatus according to one aspect of the disclosure comprises a plurality of optical elements configured to direct light from an environment toward an image sensor. The apparatus further comprises one or more support structures coupled to the plurality of optical elements. According to this aspect, the one or more support structures are configured to support each of the plurality of optical elements at a relative location with respect to the image sensor. According to this aspect, each of the plurality of optical elements is configured to receive light from the environment based on a different field of view, as received light, and direct the received light toward the image sensor.

### BACKGROUND

### Field of Disclosure

Aspects of the disclosure relate generally to image capture. More specifically, aspects discussed below relate to capturing images from an expanded field of view.

Image-based processing has increasingly grown in numerosity, sophistication, and diversity of applications. Machine learning (ML) and artificial intelligence (AI) advancements have accelerated the utilization of captured images as solutions to everyday problems. The performance of such systems can depend on the inherent qualities of the images captured. Cost effective hardware for image capture can be widely used but may have inherent limitations that restrict the capabilities of the image-based solution. On the other hand, expensive and specialized hardware may only be useful for certain applications and not suitable for many other applications due to cost or physical properties such as excessive weight or dimensions. Improvements in the capabilities of cost-effective image capture hardware can greatly expand the potential of image-based applications.

### BRIEF SUMMARY

A brief summary is presented below of one or more aspects of the present disclosure. The summary is not an extensive description of all features and not intended to identify key or critical elements of all aspects of the disclosure. Instead, the summary is intended to provide some concepts of one or more related concepts as a prelude to the more detailed description that is presented in subsequent sections.

An apparatus for image capture is presented according to one aspect of the disclosure. The apparatus comprises a plurality of optical elements configured to direct light from an environment toward an image sensor. The apparatus further comprises one or more support structures coupled to the plurality of optical elements. According to this aspect, the one or more support structures are configured to support each of the plurality of optical elements at a relative location with respect to the image sensor. According to this aspect, each of the plurality of optical elements is configured to receive light from the environment based on a different field of view, as received light, and direct the received light toward the image sensor.

A method for aiding image capture is presented according to one aspect of the disclosure. The method comprises providing a plurality of optical elements configured to direct light from an environment toward an image sensor. The method further comprises providing one or more support structures coupled to the plurality of optical elements, the one or more support structures configured to support each of the plurality of optical elements at a relative location with respect to the image sensor. The method further comprises receiving, at each of the plurality of optical elements, light from the environment based on a different field of view, as received light, and direct the received light toward the image sensor.

A system for aiding image capture is presented according to one aspect of the disclosure. The system comprises means for providing a plurality of optical elements configured to direct light from an environment toward an image sensor. The system further comprises means for providing one or more support structures coupled to the plurality of optical elements, the one or more support structures configured to support each of the plurality of optical elements at a relative location with respect to the image sensor. The system further comprises means for receiving, at each of the plurality of optical elements, light from the environment based on a different field of view, as received light, and direct the received light toward the image sensor.

A non-transitory computer readable memory storing instructions for execution by one or more processing units is presented according to one aspect of the disclosure. The stored instructions comprise instructions to capture a plurality of images based on light from a plurality of optical elements configured to direct light from an environment toward an image sensor. According to this aspect of the disclosure, light is received at each of the plurality of optical elements from the environment based on a different field of view and directed toward the image sensor by the optical element. According to this aspect, the one or more support structures are coupled to the plurality of optical elements and configured to support each of the plurality of optical elements at a relative location with respect to the image sensor.

### BRIEF DESCRIPTION OF THE DRAWINGS

Aspects of the disclosure are illustrated by way of example. In the accompanying figures, like reference numbers indicate similar elements.

FIG. 1 illustrates a simplified diagram of an environment in which aspects of the present disclosure may be utilized.

FIG. 2 presents further details of an image capture apparatus capable of capturing an expanded field of view, according to an embodiment of the disclosure.

FIG. 3 is a cross-sectional view of an image capture apparatus illustrating the convergence of light projections from different optical elements onto a common image sensor, according to embodiments of the disclosure.

FIG. 4 is a cross-sectional view of an image capture apparatus illustrating a plurality of shutters used for controllably blocking light, according to embodiments of the disclosure.

FIG. 5 is a cross-sectional view of an image capture apparatus illustrating a plurality of refractive lenses used as optical elements, according to embodiments of the disclosure.

FIG. 6 is a cross-sectional view of an image capture apparatus illustrating a plurality of diffractive optical elements, according to embodiments of the disclosure.

FIG. 7 presents an image capture apparatus that utilizes light guides to direct light received at a plurality of optical elements to an image sensor, according an embodiment of the disclosure.

FIG. 8 is a circuit diagram illustrating a control circuit 800 for providing signals to control a plurality of shutters, in accordance with an embodiment of the present disclosure.

FIG. 9 is a flowchart presenting features of a process for image capture according to an aspect of the disclosure.

FIG. 10 is a block diagram of various hardware and software components of a vehicle, according to an aspect of the disclosure.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

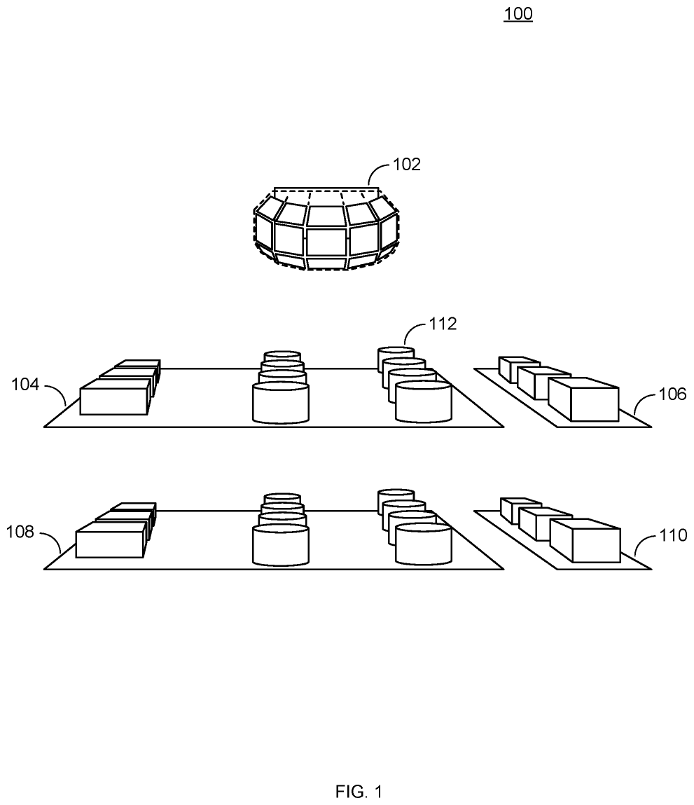

FIG. 1 illustrates a simplified diagram of an environment 100 in which aspects of the present disclosure may be utilized. In this example, environment 100 is shown as a retail environment, in which merchandise is presented to customers and offered for sale. An example of image capture apparatus 102 capable of capturing an expanded field of view is shown. Shelves 104, 106, 108, and 110 are laid out for displaying merchandise for customers to peruse. Products 112 are placed at designated spaces on the shelves 104, 106, 108, and 110. The image capture apparatus 102 captures images of the products 112 and shelves 104, 106, 108, and 110 as shoppers take products off shelves to make purchases. A computer system may process and analyze the captured images to determine, for example, the extent to which a particular product has been depleted on a shelve and needs re-stocking. The system may, for example, employ ML/AI-based approaches to recognize the products and/or stock levels of particular products.

According to some embodiments, the image capture apparatus 102 is capable of capturing images from an expanded field of view, including a wide lateral field of view. Such a wide lateral field of view may cover, for example, a long stretch of shelving. Generally speaking, in a retail shopping context, shelves are designed to have a limited depth and a wide lateral dimension to maximize the display of merchandise to customers. For example, while shelf 104 is shown in the figure as displaying just three bins of products for simplicity of illustration, an actual shelf may display tens or even hundreds of bins of products, making the shelf quite wide from the perspective of the customer. There may also be multiple shelves, such as shelves 104 and 106 on the same level. The expanded field of view of the image capture apparatus 102, given its wide lateral field of view, may cover the entire expanse of a wide shelf and/or multiple shelves on the same level.

According to some embodiments, the image capture apparatus 102 is capable of capturing images from an expanded field of view, including a large vertical field of view. Such a large vertical field of view may cover, for example, multiple levels of shelving. Two levels of shelves are shown in the figure for illustrative purposes, including a first level comprising shelves 104 and 106 and a second level comprising shelves 108 and 110. While only two levels of shelves are shown here, many more levels of shelves may be present in a retail context. The expanded field of view of the image capture apparatus 102, given its large vertical field of view, may cover multiple levels of shelves.

While a retail environment 100 is shown in this particular example, aspects of the present disclosure are not limited to retail environment 100 and can be applied in a wide variety of environments. Just as another example, a warehouse environment in which inventory of goods (e.g., on pallets and/or in bays) may be monitored through the use of captured images, e.g., to aid in automation of ordering and refiling of stock levels. Yet another example may be a wilderness environment in which flora or fauna may be monitored through the use of captured images, e.g., to observe change such as population growth or decline, behavior of plants and/or animals, movement of herds, etc. The expanded field of view of the image capture apparatus 102, including a wide lateral field of view and/or large vertical field of view, provides the capability to capture images from a greater portion of the environment.

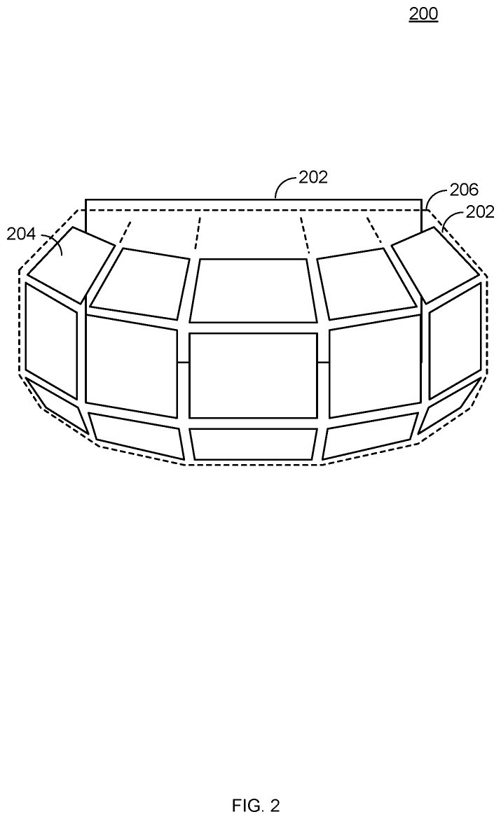

FIG. 2 presents further details of an image capture apparatus 200 capable of capturing an expanded field of view, according to an embodiment of the disclosure. The image capture apparatus 200 may be an example of the image capture apparatus 102 shown in FIG. 1. Here, the image capture apparatus 200 comprises an image sensor 202 and a plurality of optical elements 204. The image sensor 202 may comprise an array of photodetectors (e.g., photodiodes) configured to convert photons of light into electrical or other types of signals. Each photodetector may correspond to a pixel of the captured image. The image sensor 202 may capture black and white images and/or color images. The image sensor 202 may capture color images by employing color differentiation elements, such a filters based on spectrum bands and photodetectors arranged in repeated, color-based patterns, such as a Bayer pattern.

The optical elements 204 direct light from different fields of view toward the image sensor 202. Each of the optical elements 204 may be positioned in a different outward orientation, to receive light from a field of view unique to that optical element. Each optical element 204 directs the light received from its respective field of view and directs the received light toward the image sensor 202. While the fields of view corresponding to different optical elements 204 may be different, these fields of view may overlap to some extent, at least in some embodiments. Here, an optical element broadly refers to a structure or collection of structures that directs light in a desired fashion. In some embodiments, an optical element may comprise one or more facets, lenses, gratings, reflectors, other optical structures, or any combination thereof. In some embodiments, the plurality of optical elements may be formed as part of a monolithic structure. For example, the plurality of optical elements may be refractive shapes or diffractive gratings that are cast, machined, or otherwise formed in a common structure (e.g., the support structure). Thus, a monolithic structure may provide the plurality of optical elements without requiring the formation and assembly of separate components. Also, each optical element may comprise multiple features, such as multiple facets, lenses, gratings, reflectors, and/or other structures having optical properties.

In various embodiments, the light from each field of view is projected onto an area that is greater than, equal to, or less than the entire sensing surface of the image sensor 202. In some embodiments, the projection area of light from each optical element 204 covers more, the same as, or less than the total sensing surface of the image sensor 202 in a similar manner. For example, if the projection area of light from one optical element 204 is slightly greater than the total sensing surface of the image sensor 202, the projection area of light from other optical elements 204 may also be slightly greater than the total sensing area of the image sensor 202. Such a design may ensure that all pixels in an image captured by the image sensor 202 represent projected light originating from the environment and avoid dark pixels associated with regions of the sensing surface of the image sensor 202 that do not receive projected light from the corresponding optical element 204. The image capture apparatus 200 does not necessarily apply the same optical qualities to each path of projected light. For example, different paths of projected light can be associated with different fields of view, different amounts of optical distortion, different amount of light captured, etc. The plurality of optical elements 204 may have different sizes, shapes, and/or constructions.

In the embodiment shown, the image capture apparatus 200 also comprises a support structure 206. The support structure 206 may support each of the optical elements 204 and hold each optical element 204 at a fixed relative location with respect to the image sensor 202. Here, the support structure 206 has an outer surface comprising a plurality of facets 208. In some embodiments, the support structure 206 comprises a three-dimensional, transparent structure. For instance, the three-dimensional, transparent structure may comprise a glass material or a polymer material. Examples of such polymer materials include, but are not limited to, polycarbonate materials. The shape of the three-dimensional, transparent structure may be formed using one or more molds or achieved by machine milling, polishing, or other mechanical processes. The three-dimensional, transparent structure lends itself to practical manufacturability and provides solid support for mounting optical elements 204 at desired positions relative to the image sensor 202.

For example, the outer surface of the three-dimensional, transparent structure may comprise (1) a facet for coupling with the image sensor 202 and (2) a plurality of additional facets for coupling with the plurality of optical elements 204. Each facet may be formed at a specified translational and rotational position (e.g., six degrees of freedom, including three components translational displacement along x, y, and z axes, as well as three components of rotational displacement around x, y, and z axes) with respect to the positions of the other facets. By controlling the locations and angles of the various facets during manufacturing of the three-dimensional, transparent structure, the relative position of each optical element 204 with respect to the image sensor 202 can be predetermined and fixed. Then, the optical elements 204 and image sensor 202 can simply be mechanically coupled to the three-dimensional, transparent structure using the facets. This facilitates convenient assembly of the components while ensuring their desired positions relative to one another.

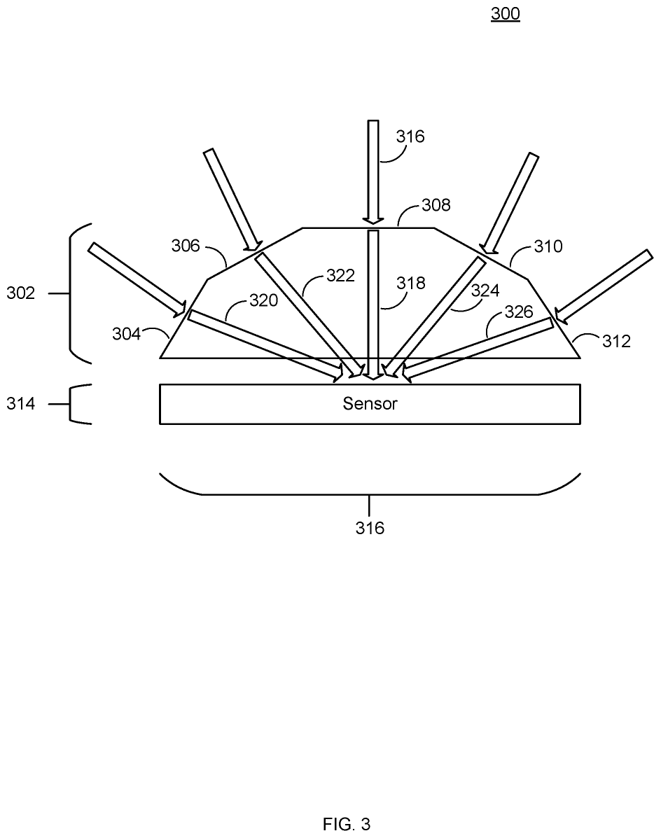

FIG. 3 is a cross-sectional view of an image capture apparatus 300 illustrating the convergence of light projections from different optical elements onto a common image sensor, according to embodiments of the disclosure. The image capture apparatus 300 may be an example of the image capture apparatus 102 shown in FIG. 1. As shown, the image capture apparatus 300 comprises a support structure 302. The support structure 302 may be a three-dimensional, transparent structure having a plurality of facets 304, 306, 308, 310, and 312. For simplicity of illustration, optical elements positioned at each of the facets 304, 306, 308, 310, and 312 are not explicitly shown in this figure. Examples of such optical elements are described in more detail in later sections of the present disclosure. While only five facets 304, 306, 308, 310, and 312 along a range of horizontal angles are shown in this cross-sectional view, the support structure 302 may encompass additional facets (not shown), e.g., facets arranged along one or more different vertical angles.

The optical elements direct light received from different fields of view of the environment to an image sensor 314. For example, a beam of received light 316 corresponding to a particular field of view may be received by an optical element corresponding to the facet 308. The beam of received light 316 may take on different shapes. Just as an example, the beam of received light 316 may take on the shape of a cone with a circular or oval cross section. As another example, the beam of received light 316 may take on the shape of a hexahedron, with a rectangular cross section. The optical element corresponding to facet 308 may direct the beam of received light as a projection 318 toward the image sensor 314. Optical elements corresponding to each of the other facets 304, 306, 310, and 312 may be configured to receive light from other fields of view of the environment and project their respective beams of light toward the same image sensor 314. These other projections are shown as projections 320, 322, 324, and 326.

For ease of illustration, each projection of light, such as projections 318, 320, 322, 324, and 326, is shown in the figure using a narrow arrow. However, it should be understood that each projection of light may attain a cross sectional area that is large enough to substantially cover (and in some embodiments, exceed the bounds of) the sensing area of the image sensor 314. For example, the cross-sectional area of the projection 318 may grow as the projection 318 gets closer to the image sensor 314. By the time the projection 318 reaches the image sensor 314, the cross-sectional area of the projection 318 may substantially cover (or completely cover, or be larger than) the total sensing surface 316 of the image sensor 314. Similarly, each of the other projections 320, 322, 324, and 326 may also reach and substantially cover (or completely cover, or be larger than) the total sensing surface 316 of the image sensor 314. In this manner, image capture apparatus 300 may be configured to direct projections of light received from different fields of view of the environment and overlap the projections onto the image sensor 314.

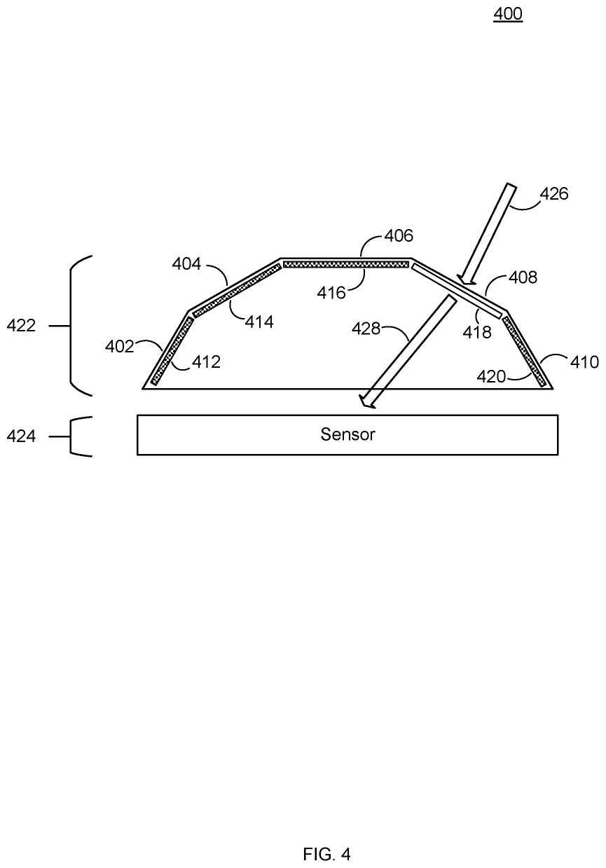

FIG. 4 is a cross-sectional view of an image capture apparatus 400 illustrating a plurality of shutters used for controllably blocking light, according to embodiments of the disclosure. The image capture apparatus 400 may be an example of the image capture apparatus 102 shown in FIG. 1. As shown, the image capture apparatus 400 further comprises a plurality of shutters, including shutters 402, 404, 406, 408, and 410. Each of the shutters 402, 404, 406, 408, and 410 may be directly or indirectly affixed to a corresponding facet from a plurality of facets 412, 414, 416, 418, and 420. As discussed previously, the plurality of facets may be part of a support structure 422. The support structure 422 may be, for example, a three-dimensional, transparent structure.

Each of the plurality of shutters 402, 404, 406, 408, and 410 may be independently operable to be placed in (1) an open position and (2) a closed position at different times. In the open position, a shutter is configured to allow light from a corresponding optical element to reach the image sensor 424, and wherein in the closed position, the shutter is configured to block light from the corresponding optical element from reaching the image sensor 424. For simplicity of illustration, optical elements positioned at each of the facets 412, 414, 416, 418, and 420 are not explicitly shown in this figure. Examples of such optical elements are described in more detail in later sections of the present disclosure.

Control signals may be used to sequentially select different ones of the plurality of shutters 402, 404, 406, 408, and 410 for opening at different times. According to embodiments of the disclosure, at any given time, a selected one of the plurality of shutters may be placed in the open position while remaining ones of the plurality of shutters are placed in the closed position. For example, at the time depicted in the figure, shutter 408 is in the “open” position, while the other shutters 402, 404, 406, and 410 are in the “closed” position. With the shutter 408 in the open position, a beam of received light 426 corresponding to a particular field of view may be received by an optical element (not shown) corresponding to the facet 408. The optical element may direct the beam of received light as a projection 428 toward the image sensor 424. At the same time, with the other shutters 402, 404, 406, and 410 in the closed position, other beams of potentially received light corresponding to other fields of view may be blocked. In this manner, the plurality of shutters 402, 404, 406, 408, and 410 may be controlled to selectively choose different beams of light received from different fields of view of the environment to be projected onto the image sensor 424. Here, the “closed” position refers to a state in which light is intended to be blocked from a particular path. In some implementations, the blockage of light isn't perfect, e.g., due to gaps in the blocking element, minor misalignment, etc. As such, leakage light may exist, even in the “closed” position.

The image capture apparatus 400 thus achieves an expanded field of view comprising the plurality of different, individual fields of view, while utilizing a single image sensor to capture image content. This is achieved by operating a plurality of shutters, such as shutters 402, 404, 406, 408, and 410 to selectively block or admit overlapping projections of received light from different fields of view onto a single image sensor. The resulting images captured, which correspond to different fields of view, may be jointly or separately processed in a myriad of applications.

The plurality of shutters 402, 404, 406, 408, and 410 may be implemented using different types of technology. According to some embodiments, each shutter comprises a liquid crystal element having liquid crystals operable in (1) the open position and (2) the closed position at different times, based on the control signals provided by the control circuitry. a micro-electro-mechanical systems (MEMS) structure operable in (1) the open position and (2) the closed position at different times, based on the control signals provided by the control circuitry.

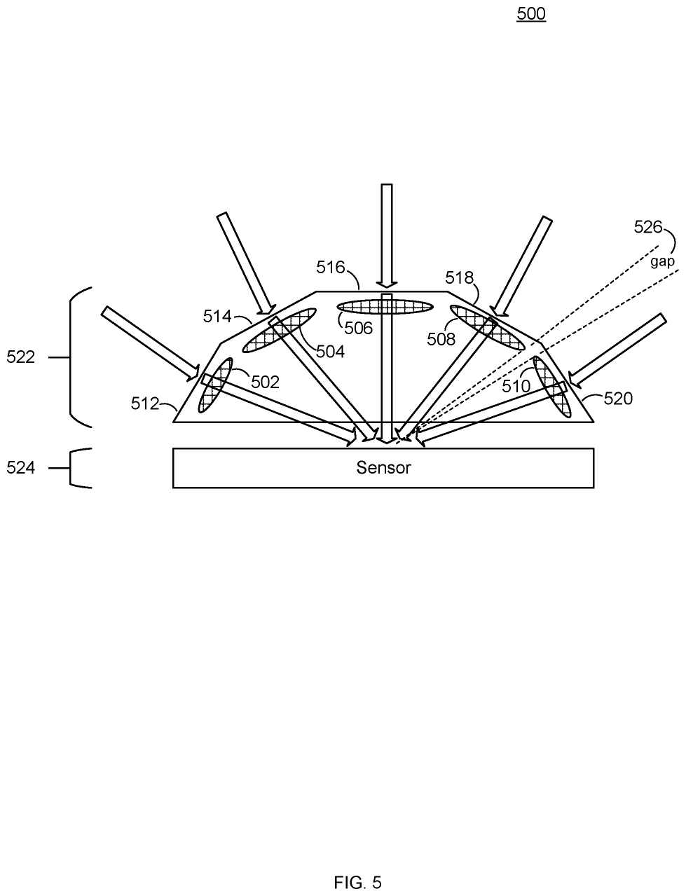

FIG. 5 is a cross-sectional view of an image capture apparatus 500 illustrating a plurality of refractive lenses used as optical elements, according to embodiments of the disclosure. The image capture apparatus 500 may be an example of the image capture apparatus 102 shown in FIG. 1. As shown, the image capture apparatus 500 further comprises a plurality of optical elements implemented as refractive lenses 502, 504, 506, 508, and 510. Each of the refractive lenses 502, 504, 506, 508, and 510 may be directly or indirectly affixed to a corresponding facet from a plurality of facets 512, 514, 516, 518, and 520. As discussed previously, the plurality of facets may be part of a support structure 522. The support structure 522 may be, for example, a three-dimensional, transparent structure. The optical elements may be configured to project received light from different fields of view onto an image sensor 524.

While refractive lenses are shown in the present figure, other types of optical features may be incorporated. For example, reflective elements, while not explicitly shown, may be incorporated along light paths that direct a field of view toward the image sensor. A reflective element may be rotatable and/or otherwise movable, to direct and/or distinguish light paths. A combination of refractive, diffractive, and/or reflective elements may be used along any given light path to direct a field of view of the environment toward the image sensor.

The refractive lenses 502, 504, 506, 508, and 510 may comprise a material suitable for light refraction, including a glass material, a polymer material such as polycarbonate, etc. According to some embodiments, the refractive lenses 502, 504, 506, 508, and 510 are made from a material having an index of refraction different from that of the material constituting the support structure 522. In some embodiments, the refractive lenses 502, 504, 506, 508, and 510 may be positioned fully beneath an outer surface of the support structure 522. For example, each of the refractive lenses 502, 504, 506, 508, and 510 may be positioned beneath a corresponding one of the facets 512, 514, 516, 518, and 520, which may constitute a portion of the outer surface of the support structure 522. In other embodiments, the refractive lenses 502, 504, 506, 508, and 510 may protrude from the support structure 522. In such embodiments, the refractive lenses 502, 504, 506, 508, and 510 may form a part of the facets and outer surface of the support structure 522.

A plurality of shutters corresponding to the plurality of refractive lenses 502, 504, 506, 508, and 510 may be implemented in the image capture apparatus 500. For ease of illustration, such shutters are not explicitly shown in the present figure. However, it should be understood that such shutters may be present. In some embodiments, each shutter is positioned above a corresponding optical element (i.e., refractive lens), to controllably block light received from a field of view of the environment prior to the light encountering the optical element. In some embodiments, each shutter is positioned below a corresponding optical element (i.e., refractive lens), to controllably block light received from a field of view of the environment after the light has passed through the optical element but prior to the light projecting onto the image sensor 524.

According to some embodiments, the support structure 522 may incorporate one or more dividers for isolating a light path between an optical element and the image sensor 524. Gaps between adjacent optical elements and/or shutters may be formed as result of imperfect abutment of neighboring components. An example is a gap 526 formed between adjacent refractive lenses 508 and 510 (and/or shutters corresponding to refractive lenses 508 and 510). Such gaps may cause light leakage that impacts the quality of the captured images. For example, refractive lens 506 may be selected for transmission of light from a particular field of view of the environment, by opening the shutter corresponding to refractive lens 506 and closing shutters corresponding to the other refractive lenses 502, 504, 508, and 510. At this time, ideally no light other than that received by the refractive lens 506 is projected onto the image sensor 524. However, gaps between the other refractive lenses 502, 504, 508, and 510 (and/or their corresponding shutters) may introduce leakage light that can also be projected onto image sensor 524, degrading the quality of the captured image. According to some embodiments, the support structure 522 may incorporate one or more dividers that isolate the path of the projected light between each optical element and the image sensor 524. Such dividers may block stray light introduced into the support structure 522 through gaps such as gap 526.

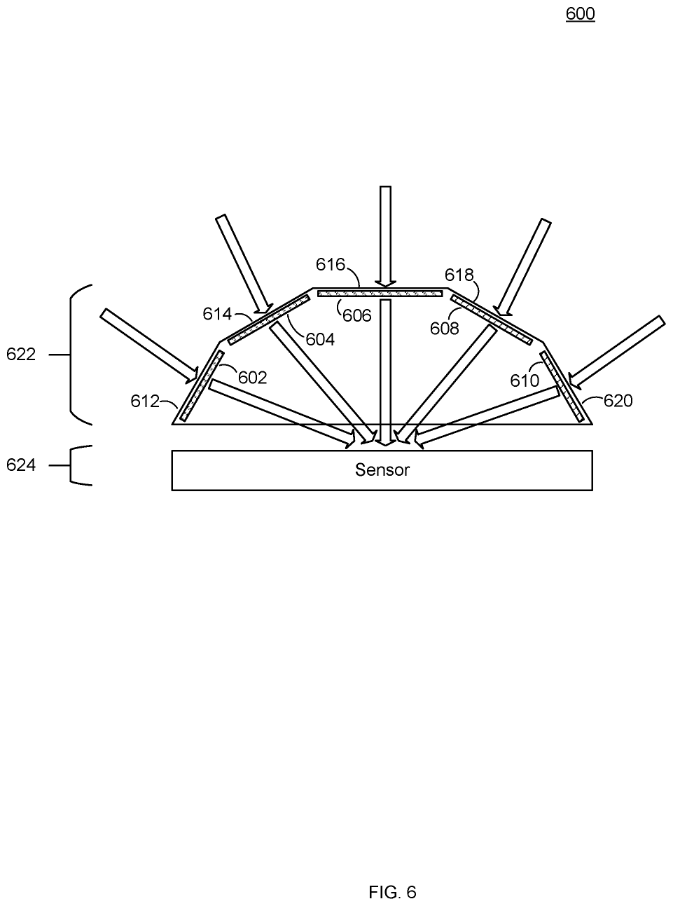

FIG. 6 is a cross-sectional view of an image capture apparatus 600 illustrating a plurality of diffractive optical elements, according to embodiments of the disclosure. The image capture apparatus 600 may be an example of the image capture apparatus 102 shown in FIG. 1. As shown, the image capture apparatus 600 further comprises a plurality of optical elements implemented as diffractive optical elements 602, 604, 606, 608, and 610. Each of the diffractive optical elements 602, 604, 606, 608, and 610 may be directly or indirectly affixed to a corresponding facet from a plurality of facets 612, 614, 616, 618, and 620. As discussed previously, the plurality of facets may be part of a support structure 622. The support structure 622 may be, for example, a three-dimensional, transparent structure. The optical elements may be configured to project received light from different fields of view onto an image sensor 624.

The diffractive optical elements 602, 604, 606, 608, and 610 may comprise a diffractive grating film. Each of the diffractive optical elements 602, 604, 606, 608, and 610 may comprise diffractive gratings configured to receive light from a particular field of view of the environment and direct the received light as a projection toward the image sensor 624. The planar shape of diffractive optical elements 602, 604, 606, 608, and 610 may facilitate ease of manufacturing and assembly of the image capture apparatus 600. Each diffractive optical element may be securely affixed to a corresponding shutter element, which may also have a generally planar shape. Both the diffractive optical element and the shutter element may be affixed to a corresponding facet of the support structure 622.

As eluded, a plurality of shutters corresponding to the plurality of diffractive optical elements 602, 604, 606, 608, and 610 may be implemented in the image capture apparatus 600. For ease of illustration, such shutters are not explicitly shown in the present figure. However, it should be understood that such shutters may be present. In some embodiments, each shutter is positioned above a corresponding diffractive optical element, to controllably block light received from a field of view of the environment prior to the light encountering the diffractive optical element. In some embodiments, each shutter is positioned below a corresponding diffractive optical element, to controllably block light received from a field of view of the environment after the light has passed through the diffractive optical element but prior to the light projecting onto the image sensor 624.

According to some embodiments, the support structure 622 may incorporate one or more dividers for isolating a light path between an optical element and the image sensor 624. Gaps between adjacent diffractive optical elements and/or shutters may be formed as result of imperfect abutment of neighboring components. The dividers may block stray light introduced into the support structure 622 through such gaps to improve the quality of the captured image.

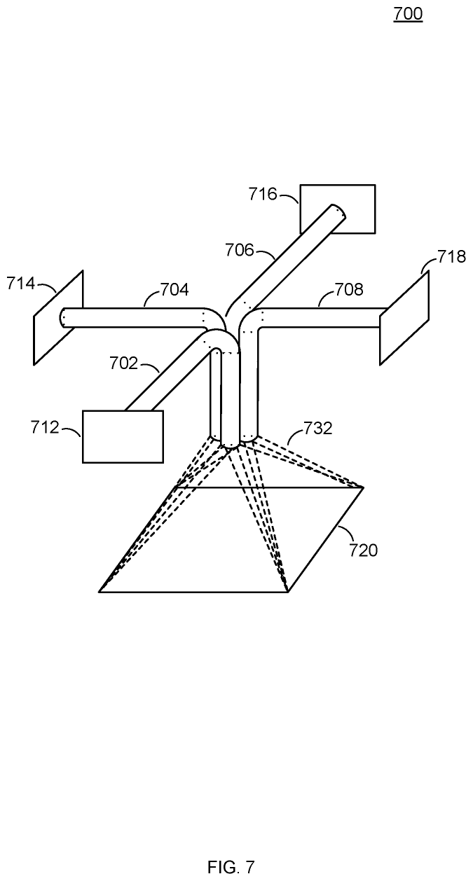

FIG. 7 presents an image capture apparatus 700 that utilizes light guides to direct light received at a plurality of optical elements to an image sensor, according an embodiment of the disclosure. The image capture apparatus 700 presents an example of optical elements being arranged in non-adjacent positions with respect to one another. As shown, the image capture apparatus 700 comprises a plurality of light guides 702, 704, 706, and 708. The light guides 702, 704, 706, and 708 direct light received from respective optical elements 712, 714, 716, and 718, which may be positioned at separate locations. Each of the optical elements 712, 714, 716, and 718 receives light from a different field of view of the environment. In this specific example, the optical element 712 receives light from a field of view toward a forward direction. The optical element 714 receives light from a field of view toward a first lateral direction. The optical element 718 receives light from a field of view toward a second lateral direction. The optical element 716 receives light from a field of view toward a rear direction. The use of flexible light guides 702, 704, 706, and 708 facilitate a wide range of field-of-view angles for the image capture apparatus 700. The image capture apparatus 700 may thus capture images from fields of view that span a range of azimuth angles (e.g., up to an entire range of 360 degrees of azimuth angles) and/or a range of pitch angles (i.e., up to an entire range of 360 degrees of pitch angles). While four optical elements are shown in this example, a different, e.g., greater or lesser number of optical elements and corresponding light guides may be deployed.

Each of the optical elements 712, 714, 716, and 718 may or may not be a refractive lens or a diffractive optical element. According to at least one embodiment, each of the optical elements 712, 714, 716, and 718 comprises an in-coupler for coupling light into a respective one of the light guides 702, 704, 706, and 708. At the other end of the light guides 702, 704, 706, and 708, light received from the different fields of view of the environment exits the light guides and is directed to the image sensor 720. Out-coupler (not shown) may be positioned at the other end of the light guides 702, 704, 706, and 708 to direct the light from the light guides 702, 704, 706, and 708 as respective projections 732 onto the image sensor 720.

A plurality of shutters corresponding to the plurality of diffractive optical elements 702, 704, 706, and 708 may be implemented in the image capture apparatus 700. For ease of illustration, such shutters are not explicitly shown in the present figure. However, it should be understood that such shutters may be present. In some embodiments, each shutter is positioned along the light path prior to a corresponding diffractive optical element, to controllably block light received from a field of view of the environment before the light encounters the diffractive optical element. In some embodiments, each shutter is positioned after a corresponding diffractive optical element, to controllably block light received from a field of view of the environment after the light has passed through the diffractive optical element but prior to the light entering the respective light guide. In some embodiments, each shutter is positioned at the other end of the respective light guide, to controllably block light received from a field of view of the environment after the light has passed through the respective light guide but prior to the light being projected onto the image sensor 720.

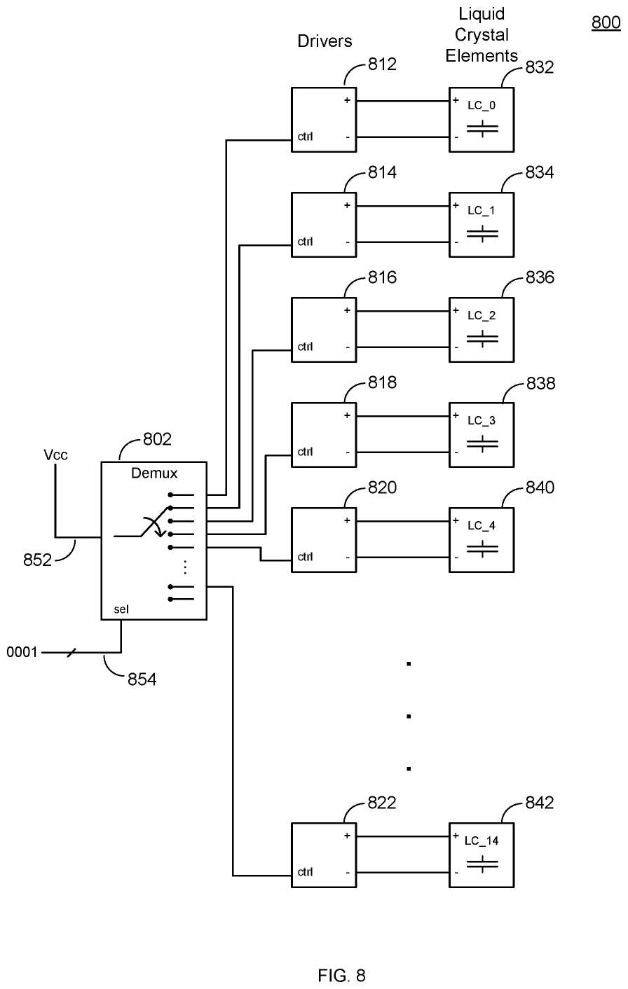

FIG. 8 is a circuit diagram illustrating a control circuit 800 for providing signals to control a plurality of shutters, in accordance with an embodiment of the present disclosure. In this example, the control circuit 800 comprises a demultiplexer 802 and a plurality of drivers 812, 814, 816, 818, 820, and 822. The drivers provide drive signals for a plurality of liquid crystal elements 832, 834, 836, 838, 830, and 842. Additional drivers and liquid crystal elements are present but are not explicitly shown in order to simplify illustration. Each of the liquid crystal elements may represent an instance of a shutter operable to be placed in (1) an open position and (2) a closed position at different times. As discussed, in the open position, each shutter is configured to allow light from a corresponding optical element to reach the image sensor. In the closed position, the shutter is configured to block light from the corresponding optical element from reaching the image sensor.

The demultiplexer 802 receives an input signal 8 and a selection signal 854. In this example, the input signal 852 is connected to a logical “1” (e.g., Vcc). The selection signal 854 in this example is four bits wide. Based on the value of the selection signal 854, the demultiplexer 802 connects the input signal 852 to one of its output ports. Thus, the demultiplexer 802 selectively outputs a logical “1” value to the selected output port, while providing a logical “0” to the other, non-selected output ports.

The output ports of the demultiplexer 802 are provided as input signals to the plurality of drivers 812, 814, 816, 818, 820, and 822. For each driver, if the input signal indicates a logical “1,” the driver provide necessary driving voltage and/or current on its output ports to drive the corresponding liquid crystal element to the “open” position. If the input signal to a driver indicates a logical “0,” the driver does not provide necessary driving voltage and/or current on its output ports to drive the corresponding liquid crystal element, which remains in the “closed position.” In a different implementation, the required driving voltages/currents of the liquid crystal elements may be different, or even reversed. Each driver may be configured to provide the appropriate voltage and/or current appropriate for driving the respective liquid crystal element to the desired “open” or “closed” state.

Just as an example, there may be 15 individual shutters being controlled, corresponding to the 15 optical element arranged in three rows of the image capture apparatus 200 depicted in FIG. 2. These 15 shutters may be implemented as liquid crystal elements LC_0 through LC_14, represented by liquid crystal elements 832, 834, 836, 838, 830, and 842 in FIG. 8. According to some embodiments, the selection signal 854 repeats a switching pattern. In each iteration of the switching pattern, every one of the plurality of shutters is selected once to be place in the open position while remaining ones of the plurality of shutters are placed in the closed position. Thus, in this example, the switching pattern may comprise 15 possible values and be arranged as follows: 0000, 0001, 0010, 0011, 0100, 0101, 0110, 0111, 1000, 1001, 1010, 1011, 1100, 1101, and 1110. In the particular moment illustrated by FIG. 8, the selection signal 854 has a value of “0001” which selects the second liquid crystal element 834 (LC_1) to be placed in the “open” position, while keeping the other liquid crystal elements 832, 836, 838, 840, and 842 (LC_0, LC2, LC_3, LC_4, . . . , LC_14) in the “closed” position. The selection signal 854 may be provided by additional circuitry (not shown), which may comprise logical circuits, one or more registers or other memory device, or one or more processors carrying out programmed instructions.

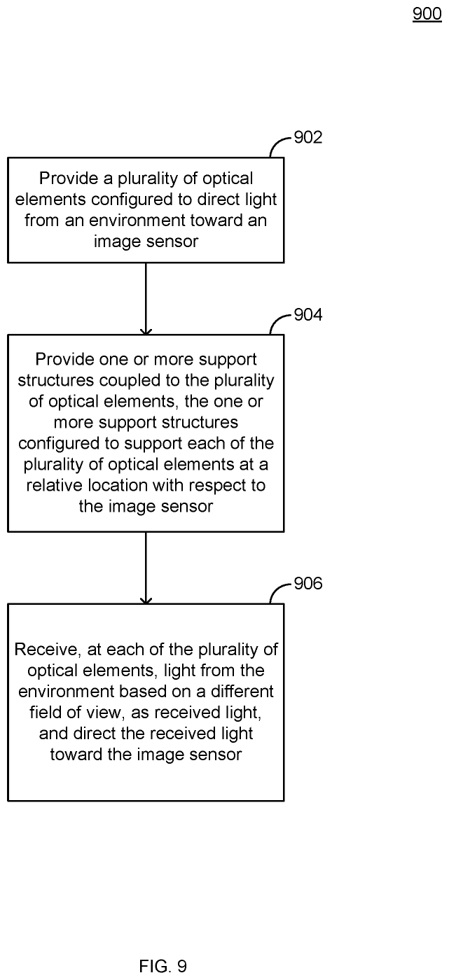

FIG. 9 is a flowchart presenting features of a process 900 for image capture according to an aspect of the disclosure. At 902 the process involves providing a plurality of optical elements configured to direct light from an environment toward an image sensor. Examples of the plurality of optical elements include optical elements 204 in FIG. 2, refractive lenses 502, 504, 506, 508, and 510 in FIG. 5, as well as diffractive optical elements 602, 604, 606, 608, and 610 in FIG. 6. At 904, the process involves providing one or more support structures coupled to the plurality of optical elements, the one or more support structures configured to support each of the plurality of optical elements at a relative location with respect to the image sensor. An example of the one or more support structures includes the support structure 206 in FIG. 2. At 906, the process involves receiving, at each of the plurality of optical elements, light from the environment based on a different field of view, as received light, and direct the received light toward the image sensor. An example of the image sensor includes the image sensor image sensor 202 shown in FIG. 2.

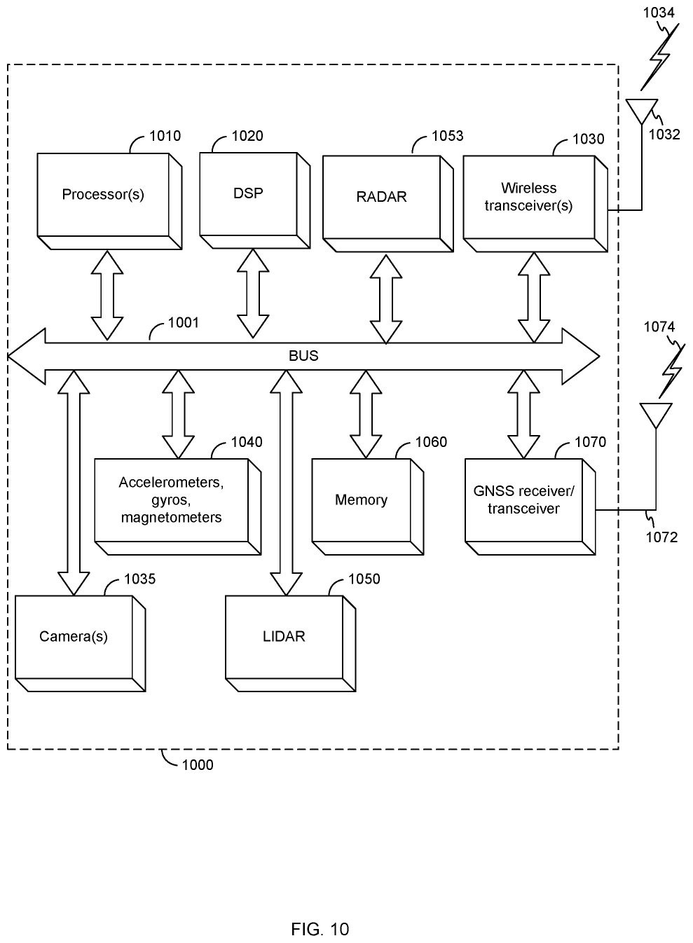

FIG. 10 is a block diagram of various hardware and software components of a device 1000 employing an image capture apparatus capable of capturing an expanded field of view, according to an aspect of the disclosure. An example of device 1000 may be an environment monitoring device, a mobile handset device, a wearable device, a vehicle, a drone, or another device taking image data as input. In one example, device 1000 may communicate, via wireless transceiver(s) 1030 and wireless antenna(s) 1032 with other devices and/or wireless communication networks by transmitting wireless signals to, or receiving wireless signals from a remote wireless transceiver which may comprise another device, a base station (e.g., a NodeB, eNodeB, or gNodeB) or wireless access point, over a wireless communication link.

Similarly, device 1000 may transmit wireless signals to, or receive wireless signals from a local transceiver over a wireless communication link, for example, by using a WLAN and/or a PAN wireless transceiver, here represented by one of wireless transceiver(s) 1030 and wireless antenna(s) 1032. In an embodiment, wireless transceiver(s) 1030 may comprise various combinations of WAN, WLAN, and/or PAN transceivers. In an embodiment, wireless transceiver(s) 1030 may also comprise a Bluetooth transceiver, a ZigBee transceiver, or other PAN transceiver. In an embodiment, device 1000 may transmit wireless signals to, or receive wireless signals from a wireless transceiver 1030 on a device 1000 over wireless communication link 1034. A local transceiver, a WAN wireless transceiver and/or a mobile wireless transceiver may comprise a WAN transceiver, an access point (AP), femtocell, Home Base Station, small cell base station, HNB, HeNB, or gNodeB and may provide access to a wireless local area network (WLAN, e.g., IEEE 802.11 network), a wireless personal area network (PAN, e.g., Bluetooth network) or a cellular network (e.g., an LTE network or other wireless wide area network such as those discussed in the next paragraph). Of course, it should be understood that these are merely examples of networks that may communicate with a device over a wireless link, and claimed subject matter is not limited in this respect. It is also understood that wireless transceiver(s) 1030 may be located on various types of devices 1000, such as boats, ferries, cars, buses, drones, and various transport vehicles. In an embodiment, the device 1000 may be utilized for passenger transport, package transport or other purposes. In an embodiment, GNSS signals 1074 from GNSS Satellites are utilized by device 1000 for location determination and/or for the determination of GNSS signal parameters and demodulated data. In an embodiment, signals 1034 from WAN transceiver(s), WLAN and/or PAN local transceivers are used for location determination, alone or in combination with GNSS signals 1074.

Examples of network technologies that may support wireless transceivers 1030 are GSM, CDMA, WCDMA, LTE, 5G or New Radio Access Technology (NR), HRPD, and V2X car-to-car communication. As noted, V2X communication protocols may be defined in various standards such as SAE and ETS-ITS standards. GSM, WCDMA and LTE are technologies defined by 3GPP. CDMA and HRPD are technologies defined by the 3rd Generation Partnership Project II (3GPP2). WCDMA is also part of the Universal Mobile Telecommunications System (UMTS) and may be supported by an HNB.

Wireless transceivers 1030 may communicate with communications networks via WAN wireless base stations which may comprise deployments of equipment providing subscriber access to a wireless telecommunication network for a service (e.g., under a service contract). Here, a WAN wireless base station may perform functions of a WAN or cell base station in servicing subscriber devices within a cell determined based, at least in part, on a range at which the WAN wireless base station is capable of providing access service. Examples of WAN base stations include GSM, WCDMA, LTE, CDMA, HRPD, Wi-Fi, Bluetooth, WiMAX, 5G NR base stations. In an embodiment, further wireless base stations may comprise a WLAN and/or PAN transceiver.

In an embodiment, device 1000 may contain one or more cameras 1035, which may comprise an image capture apparatus capable of capturing an expanded field of view according to various embodiments of the present disclosure. In an embodiment, the camera may comprise a camera sensor and mounting assembly. Different mounting assemblies may be used for different cameras on device 1000. The cameras may provide object detection and distance estimation, particularly for objects of known size and/or shape. When used in concert with the other sensors, the cameras may both be calibrated through the use of other systems such as through the use of LIDAR, wheel tick/distance sensors, and/or GNSS to verify distance traveled and angular orientation. The cameras may similarly be used to verify and calibrate the other systems to verify that distance measurements are correct, for example by calibrating against known distances between known objects (landmarks, roadside markers, road mile markers, etc.) and also to verify that object detection is performed accurately such that objects are accordingly mapped to the correct locations relative to the car by LIDAR and other system.

Accelerometers, gyros and magnetometers 1040, in an embodiment, may be utilized to provide and/or verify motion and directional information. LIDAR 1050 uses pulsed laser light to measure ranges to objects. While cameras may be used for object detection, LIDAR 1050 provides a means, to detect the distances (and orientations) of the objects with more certainty, especially in regard to objects of unknown size and shape. LIDAR 1050 measurements may also be used to estimate rate of travel, vector directions, relative position and stopping distance by providing accurate distance measurements and delta distance measurements.

Memory 1060 may be utilized with processor 1010 and/or DSP 1020, which may comprise Random Access Memory (RAM), Read-Only Memory (ROM), disc drive, FLASH, or other memory devices or various combinations thereof. In an embodiment, memory 1060 may contain instructions to implement various methods described throughout this description. In an embodiment, memory may contain instructions for operating and calibrating sensors, and for receiving map, weather, and other data.

A global navigation satellite system (GNSS) receiver 1070 may be utilized to determine position relative to the earth (absolute position) and, when used with other information such as measurements from other objects and/or mapping data, to determine position relative to other objects such as relative to other vehicles and/or relative to the road surface. To determine position, the GNSS receiver/transceiver/transceiver 1070, may receive RF signals 1074 from GNSS satellites using one or more antennas 1072 (which, depending on functional requirements, may be the same as antennas 1032). The GNSS receiver/transceiver/transceiver 1070 may support one or more GNSS constellations as well as other satellite-based navigation systems. For example, in an embodiment, GNSS receiver/transceiver/transceiver 1070 may support global navigation satellite systems such as GPS, the GLONASS, Galileo, and/or BeiDou, or any combination thereof. In an embodiment, GNSS receiver/transceiver 1070 may support regional navigation satellite systems such as NavIC or QZSS or a combination thereof as well as various augmentation systems (e.g., Satellite Based Augmentation Systems (SBAS) or ground based augmentation systems (GBAS)) such as Doppler Orbitography and Radio-positioning Integrated by Satellite (DORIS) or wide area augmentation system (WAAS) or the European geostationary navigation overlay service (EGNOS) or the multi-functional satellite augmentation system (MSAS) or the local area augmentation system (LAAS). In an embodiment, GNSS receiver/transceiver(s) 1030 and antenna(s) 1032 may support multiple bands and sub-bands such as GPS L1, L2 and L5 bands, Galileo E1, E5, and E6 bands, Compass (BeiDou) B1, B3 and B2 bands, GLONASS G1, G2 and G3 bands, and QZSS L1C, L2C and L5-Q bands.

The GNSS receiver/transceiver 1070 may be used to determine location and relative location which may be utilized for location, navigation, and to calibrate other sensors, when appropriate, such as for determining distance between two time points in clear sky conditions and using the distance data to calibrate other sensors such as the odometer and/or LIDAR. In an embodiment, GNSS-based relative locations, based on, for example shared Doppler and/or pseudorange measurements between vehicles, may be used to determine highly accurate distances between two vehicles, and when combined with vehicle information such as shape and model information and GNSS antenna location, may be used to calibrate, validate and/or affect the confidence level associated with information from LIDAR, camera, RADAR, SONAR and other distance estimation techniques.

RADAR 1053, uses transmitted radio waves that are reflected off of objects. The reflected radio waves are analyzed, based on the time taken for reflections to arrive and other signal characteristics of the reflected waves to determine the location of nearby objects. RADAR 1053 may be utilized to detect the location of nearby cars, roadside objects (signs, other vehicles, pedestrians, etc.) and will generally enable detection of objects even if there is obscuring weather such as snow, rail or hail. Thus, RADAR 1053 may be used to complement LIDAR 1050 systems and camera 1035 systems in providing ranging information to other objects by providing ranging and distance measurements and information when visual-based systems typically fail. Furthermore, RADAR 1053 may be utilized to calibrate and/or sanity check other systems such as LIDAR 1050 and camera 1035.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory (e.g., memory 1060 of FIG. 10) can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. The term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. An apparatus for image capture comprising: a plurality of optical elements configured to direct light from an environment toward an image sensor; and one or more support structures coupled to the plurality of optical elements, the one or more support structures configured to support each of the plurality of optical elements at a relative location with respect to the image sensor, wherein each of the plurality of optical elements configured to receive light from the environment based on a different field of view, as received light, and direct the received light toward the image sensor.

Clause 2. The apparatus of clause 1, wherein the plurality of optical elements are arranged in laterally adjacent positions with respect to one another.

Clause 3. The apparatus of clause 1 or 2, wherein the one or more support structures comprises a three-dimensional, transparent structure.

Clause 4. The apparatus of clause 3, wherein the three-dimensional, transparent structure comprises an outer surface having a plurality of facets, each of the plurality of facets configured to support one of the plurality of optical elements in a fixed position with respect to the image sensor.

Clause 5. The apparatus of any of clauses 3-4, wherein the three-dimensional, transparent structure comprises one or more dividers for isolating a light path between an optical element and the image sensor.

Clause 6. The apparatus of any of clauses 3-5, wherein the three-dimensional, transparent structure comprises a glass material.

Clause 7. The apparatus of any of clauses 3-6, wherein the three-dimensional, transparent structure comprises a polymer material.

Clause 8. The apparatus of clause 7, wherein the polymer material comprises a polycarbonate material.

Clause 9. The apparatus of any of clauses 1-8, wherein the plurality of optical elements are in non-adjacent positions with respect to one another.

Clause 10. The apparatus of any of clauses 1-9, further comprising a plurality of light guides, each of the plurality of light guides configured to guide light received by one of the plurality of optical elements toward the image sensor.

Clause 11. The apparatus of any of clauses 1-10, wherein each of the plurality of optical elements comprises a diffractive optical element.

Clause 12. The apparatus of clause 11, wherein the diffractive optical element comprises a diffractive grating film.

Clause 13. The apparatus of any of clauses 1-12, wherein the each of the plurality of optical elements comprises a refractive lens.

Clause 14. The apparatus of any of clauses 1-13, wherein the plurality of optical elements have a uniform size.

Clause 15. The apparatus of any of clauses 1-14, wherein the plurality of optical elements have different sizes.

Clause 16. The apparatus of any of clauses 1-15, wherein a first one of the plurality of optical elements has a first size and is located at a first position relative to a center axis of the image sensor, and a second one of the plurality of optical elements has a second size and is located at a second position farther than the first position relative to the center axis of the image, the first size being smaller than the second size.

Clause 17. The apparatus of any of clauses 1-15, wherein a first one of the plurality of optical elements has a first size and is located at a first position relative to a center axis of the image sensor, and a second one of the plurality of optical elements has a second size and is located at a second position farther than the first position relative to the center axis of the image, the first size being larger than the second size

Clause 18. The apparatus of any of clauses 1-17, further comprising a plurality of shutters coupled to the plurality of optical elements, each shutter of the plurality of shutters operable in (1) an open position and (2) a closed position at different times, wherein in the open position, the shutter is configured to allow light from a corresponding optical element to reach the image sensor, and wherein in the closed position, the shutter is configured to block light from the corresponding optical element from reaching the image sensor.

Clause 19. The apparatus of clause 18, wherein each shutter of the plurality of comprises a liquid crystal element having liquid crystals operable in (1) the open position and (2) the closed position at different times, based on the control signals provided by the control circuitry.

Clause 20. The apparatus of clause 18, wherein each shutter of the plurality of shutters comprises a micro-electro-mechanical systems (MEMS) structure operable in (1) the open position and (2) the closed position at different times, based on the control signals provided by the control circuitry.

Clause 21. The apparatus of any of clauses 18-20, further comprising control circuitry configured to provide control signals to the plurality of shutters, to sequentially select different ones of the plurality of shutters for opening at different times, wherein a selected one of the plurality of shutters is placed in the open position while remaining ones of the plurality of shutters are placed in the closed position.

Clause 22. The apparatus of clause 21, wherein the control signals repeat a switching pattern, wherein according to the switching pattern, every one of the plurality of shutters is selected once to be place in the open position while remaining ones of the plurality of shutters are placed in the closed position.

Clause 23. A method for aiding image capture comprising: providing a plurality of optical elements configured to direct light from an environment toward an image sensor; providing one or more support structures coupled to the plurality of optical elements, the one or more support structures configured to support each of the plurality of optical elements at a relative location with respect to the image sensor; and receiving, at each of the plurality of optical elements, light from the environment based on a different field of view, as received light, and direct the received light toward the image sensor.

Clause 24. The method of clause 23, wherein the one or more support structures comprises a three-dimensional, transparent structure.

Clause 25. The method of clause 24, wherein the three-dimensional, transparent structure comprises an outer surface having a plurality of facets, each of the plurality of facets configured to support one of the plurality of optical elements in a fixed position with respect to the image sensor.

Clause 26. The method of any of clauses 23-25, wherein each of the plurality of optical elements comprises a diffractive optical element.

Clause 27. The method of any of clauses 23-26, further comprising: providing a plurality of shutters coupled to the plurality of optical elements, each shutter of the plurality of shutters operable in (1) an open position and (2) a closed position at different times, wherein in the open position, the shutter is configured to allow light from a corresponding optical element to reach the image sensor, and wherein in the closed position, the shutter is configured to block light from the corresponding optical element from reaching the image sensor.

Clause 28. The apparatus of clause 27, wherein each shutter of the plurality of comprises a liquid crystal element having liquid crystals operable in (1) the open position and (2) the closed position at different times, based on the control signals provided by the control circuitry.

Clause 29. A system for aiding image capture comprising: means for providing a plurality of optical elements configured to direct light from an environment toward an image sensor; means for providing one or more support structures coupled to the plurality of optical elements, the one or more support structures configured to support each of the plurality of optical elements at a relative location with respect to the image sensor; and means for receiving, at each of the plurality of optical elements, light from the environment based on a different field of view, as received light, and direct the received light toward the image sensor.

Clause 30. A non-transitory computer readable medium storing therein for execution by one or more processing units, comprising instructions to: capture a plurality of images based on light from a plurality of optical elements configured to direct light from an environment toward an image sensor; wherein light received at each of the plurality of optical elements is from the environment based on a different field of view and directed toward the image sensor by the optical element; and wherein one or more support structures are coupled to the plurality of optical elements and configured to support each of the plurality of optical elements at a relative location with respect to the image sensor.

What is claimed is:

1. An apparatus for image capture comprising:
a plurality of optical elements configured to direct light from an environment toward an image sensor; and
one or more support structures coupled to the plurality of optical elements, the one or more support structures configured to support each of the plurality of optical elements at a relative location with respect to the image sensor,
wherein each of the plurality of optical elements configured to receive light from the environment based on a different field of view, as received light, and direct the received light toward the image sensor.

2. The apparatus of claim 1, wherein the plurality of optical elements are arranged in laterally adjacent positions with respect to one another.

3. The apparatus of claim 1, wherein the one or more support structures comprises a three-dimensional, transparent structure.

4. The apparatus of claim 3, wherein the three-dimensional, transparent structure comprises an outer surface having a plurality of facets, each of the plurality of facets configured to support one of the plurality of optical elements in a fixed position with respect to the image sensor.

5. The apparatus of claim 3, wherein the three-dimensional, transparent structure comprises one or more dividers for isolating a light path between an optical element and the image sensor.

6. The apparatus of claim 3, wherein the three-dimensional, transparent structure comprises a glass material.

7. The apparatus of claim 3, wherein the three-dimensional, transparent structure comprises a polymer material.

8. The apparatus of claim 7, wherein the polymer material comprises a polycarbonate material.

9. The apparatus of claim 1, wherein the plurality of optical elements are in non-adjacent positions with respect to one another.

10. The apparatus of claim 1, further comprising a plurality of light guides, each of the plurality of light guides configured to guide light received by one of the plurality of optical elements toward the image sensor.

11. The apparatus of claim 1, wherein each of the plurality of optical elements comprises a diffractive optical element.

12. The apparatus of claim 11, wherein the diffractive optical element comprises a diffractive grating film.

13. The apparatus of claim 1, wherein the each of the plurality of optical elements comprises a refractive lens.

14. The apparatus of claim 1, wherein the plurality of optical elements have a uniform size.

15. The apparatus of claim 1, wherein the plurality of optical elements have different sizes.

16. The apparatus of claim 15, wherein a first one of the plurality of optical elements has a first size and is located at a first position relative to a center axis of the image sensor, and a second one of the plurality of optical elements has a second size and is located at a second position farther than the first position relative to the center axis of the image, the first size being smaller than the second size.

17. The apparatus of claim 15, wherein a first one of the plurality of optical elements has a first size and is located at a first position relative to a center axis of the image sensor, and a second one of the plurality of optical elements has a second size and is located at a second position farther than the first position relative to the center axis of the image, the first size being larger than the second size

18. The apparatus of claim 1, further comprising a plurality of shutters coupled to the plurality of optical elements, each shutter of the plurality of shutters operable in (1) an open position and (2) a closed position at different times, wherein in the open position, the shutter is configured to allow light from a corresponding optical element to reach the image sensor, and wherein in the closed position, the shutter is configured to block light from the corresponding optical element from reaching the image sensor.

19. The apparatus of claim 18, wherein each shutter of the plurality of comprises a liquid crystal element having liquid crystals operable in (1) the open position and (2) the closed position at different times, based on the control signals provided by the control circuitry.

20. The apparatus of claim 18, wherein each shutter of the plurality of shutters comprises a micro-electro-mechanical systems (MEMS) structure operable in (1) the open position and (2) the closed position at different times, based on the control signals provided by the control circuitry.

21. The apparatus of claim 18, further comprising control circuitry configured to provide control signals to the plurality of shutters, to sequentially select different ones of the plurality of shutters for opening at different times, wherein a selected one of the plurality of shutters is placed in the open position while remaining ones of the plurality of shutters are placed in the closed position.

22. The apparatus of claim 21, wherein the control signals repeat a switching pattern, wherein according to the switching pattern, every one of the plurality of shutters is selected once to be place in the open position while remaining ones of the plurality of shutters are placed in the closed position.

23. A method for aiding image capture comprising:
providing a plurality of optical elements configured to direct light from an environment toward an image sensor;
providing one or more support structures coupled to the plurality of optical elements, the one or more support structures configured to support each of the plurality of optical elements at a relative location with respect to the image sensor; and
receiving, at each of the plurality of optical elements, light from the environment based on a different field of view, as received light, and direct the received light toward the image sensor.

24. The method of claim 23, wherein the one or more support structures comprises a three-dimensional, transparent structure.

25. The method of claim 24, wherein the three-dimensional, transparent structure comprises an outer surface having a plurality of facets, each of the plurality of facets configured to support one of the plurality of optical elements in a fixed position with respect to the image sensor.

26. The method of claim 23, wherein each of the plurality of optical elements comprises a diffractive optical element.

27. The method of claim 23, further comprising:
providing a plurality of shutters coupled to the plurality of optical elements, each shutter of the plurality of shutters operable in (1) an open position and (2) a closed position at different times, wherein in the open position, the shutter is configured to allow light from a corresponding optical element to reach the image sensor, and wherein in the closed position, the shutter is configured to block light from the corresponding optical element from reaching the image sensor.

28. The apparatus of claim 27, wherein each shutter of the plurality of comprises a liquid crystal element having liquid crystals operable in (1) the open position and (2) the closed position at different times, based on the control signals provided by the control circuitry.

29. A system for aiding image capture comprising:
means for providing a plurality of optical elements configured to direct light from an environment toward an image sensor;
means for providing one or more support structures coupled to the plurality of optical elements, the one or more support structures configured to support each of the plurality of optical elements at a relative location with respect to the image sensor; and
means for receiving, at each of the plurality of optical elements, light from the environment based on a different field of view, as received light, and direct the received light toward the image sensor.

30. A non-transitory computer readable medium storing therein for execution by one or more processing units, comprising instructions to:
capture a plurality of images based on light from a plurality of optical elements configured to direct light from an environment toward an image sensor;
wherein light received at each of the plurality of optical elements is from the environment based on a different field of view and directed toward the image sensor by the optical element; and
wherein one or more support structures are coupled to the plurality of optical elements and configured to support each of the plurality of optical elements at a relative location with respect to the image sensor.
